(19) United States
(12) Patent Application Publication
(10) Pub. No.: US 2017/0320112 A1
(43) Pub. Date: Nov. 9, 2017

(54) INTEGRATED AUTOMATIC TANK CLEANING SKIP

(71) Applicant: M-I Drilling Fluids UK Limited, Westhill (GB)

(72) Inventor: Martin Hunter, Aberdeen (GB)

(21) Appl. No.: 15/316,205

(22) PCT Filed: Jun. 18, 2015
(86) PCT No.: PCT/US2015/036315

§ 371 Date: Dec. 5, 2016

Related U.S. Application Data
(60) Provisional application No. 62/014,551, filed on Jun. 19, 2014.

(51) Int. Cl. B08B 9/093; E21B 21/01; E21B 21/06

(52) U.S. Cl. CPC B08B 9/0933; E21B 21/066; E21B 21/01; E21B 21/062

(57) ABSTRACT

A system includes a skip, a first sensor and a conveying section. The skip includes a hollow interior to store solids therein. The skip further includes an inlet and an outlet. The first sensor is located adjacent the inlet to indicate that the interior is filled with solids up to a predetermined level. The conveying section is located downstream of the outlet and is in solids communication with the interior. After the first sensor indicates that the interior is filled with solids up to the predetermined level, the conveying section conveys solids away from the skip and the skip is emptied. A method of using the aforementioned system is also disclosed.

### RELATED APPLICATIONS

This application claims the benefit of US Provisional Application having Ser. No. 62/014,551 filed Jun. 19, 2014, which is incorporated by reference in its entirety.

### BACKGROUND

Rotary drilling methods employing a drill bit and drill stems have long been used to drill wellbores in subterranean formations. Drilling fluids or muds are commonly circulated in the well during such drilling to cool and lubricate the drilling apparatus, lift cuttings out of the wellbore, and counterbalance the subterranean formation pressure encountered. Drilling fluids and muds often contain entrained solids which have been purposefully added, such as: weighting agents, such as barite, hematite, aluminite, and the like; viscosifying agents including sepolite clay, and other viscosifying clays; and fluid looss control agents, etc. as well as very fine solid particles generated by the drilling process. Unlike drill cuttings, these entrained solids are difficult to remove by screening. However, upon standing, the solids often settle out over long periods of time (i.e. hours to days). Thus, when the used drilling fluids or muds are being stored in tanks awaiting transport for recycling, these entrained solids typically settle out into the bottom of the tank and form a dense layer of solids.

Waste resulting from the cleaning of these tanks is stored in a skip for disposal at a later time. The disposal process often involves moving the skip to a plurality of places using a crane. For example, the skip is moved from a dock to a ship, from the ship to a central skip storage point on the rig, from the rig to the tank cleaning station and back to the central skip storage point. Therefore, cleaning a single tank can involve lifting a crane multiple times.

### BRIEF DESCRIPTION OF THE DRAWINGS

These and other aspects are better understood when the following detailed description is read with reference to the accompanying drawings, in which:

FIG. 1 is a view of an example tank cleaning system known in the art;

FIG. 2 is a close-up side view of the skip;

FIG. 3 is a view of an example environment in which the tank cleaning system may be located;

FIG. 4 is a view of an first example embodiment of the pressurized vessel;

FIG. 5 is a view of a second example embodiment of the pressurized vessel;

FIG. 6 is a schematic view of a first example embodiment of a system for the re-injection of solids; and

FIG. 7 is a schematic view of a second example embodiment of a system for the re-injection of solids.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

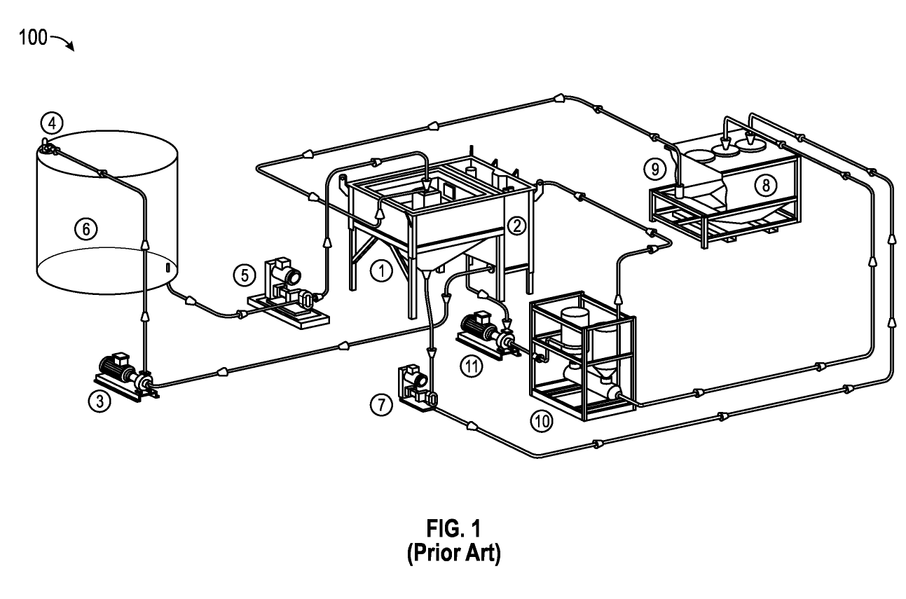

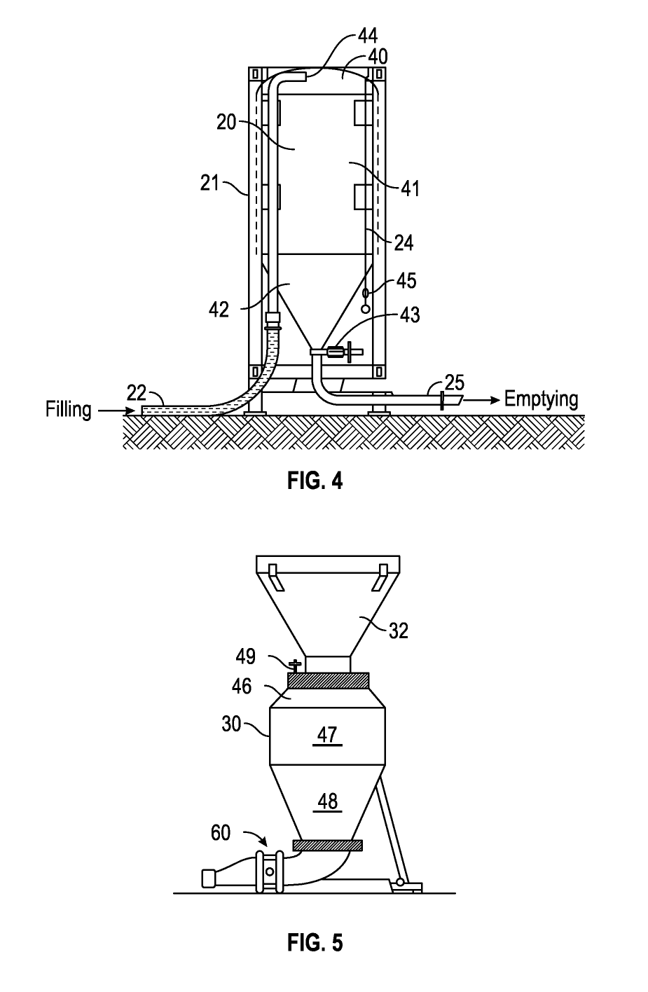

Referring now to FIG. 1, a tank cleaning system 100 is shown that cleans an interior of a mud tank 6 and recycles fluid used to clean the mud tank 6 as known in the art. The tank cleaning system 100 may be permanently installed near mud pits on a platform 13 of a drilling site (e.g., an offshore oil rig 11 in FIG. 4) and may primarily include a water recycling unit or separator 1, a buffer tank 2, the mud tank 6 and a skip 8 as shown in FIG. 1. The mud tank 6 may include a hollow interior that stores mud (i.e., drilling fluid) and may be equipped with one or more tank cleaning machines (TCM) 4 therein. The mud is used to lubricate and cool the drill bit as well as to carry the cuttings from the formation to the surface. At the surface, the mud is processed through shakers and other treatment devices to prepare the mud for recycling. The mud in the mud tank 6 may be recycled to remove the cuttings but may still contain entrained solids which have been purposefully added, such as: weighting agents, such as barite, hematite, aluminite, and the like; viscosifying agents including sepolite clay, and other viscosifying clays; and fluid loss control agents, etc. as well as very fine solid particles generated by the drilling process.

The TCMs 4 may be positioned inside each mud tank 6 and the positions of the TCMs 4 may be determined based on a cleaning pattern of the TCMs 4 and a geometric design of the interior of the mud tank 6. The TCM 4 may provide one or more fluid jets that clean the internal surfaces of the mud tank 6 by spraying fluid thereon and may be supplied with fluid through a TCM feed pump 3. The TCM feed pump 3 may send a mixture of surfactant and water to the TCMs 4. The fluid supplied to the TCM 4 may originate from the buffer tank 2. The fluid jets of the TCMs 4 clean substantially all surfaces inside the mud tank 6 and the cleaning may follow a programmable pattern. The dirty fluid (i.e., slop) may need to be removed from the bottom of the mud tank 6 through a slop pump 5 which may transfer the slop back to the separator 1.

The separator 1 may include a separator tank with a cone-shaped bottom and may separate the slop from the mud tank 6 into solids portion and fluids portion. While inside the separator tank, heavier solids portion of the slop will settle to the bottom of the separator tank and the fluids portion will overflow from the separator tank to the buffer tank 2 located adjacent the separator tank. The fluids portion may include an oil portion and a water portion. The water portion may be redirected back to the TCMs 4 to be reused as cleaning fluid. The oil portion may accumulate on top of the water portion in the buffer tank 2 and may be regularly drained into the skip 8 by using an oil drain manifold.

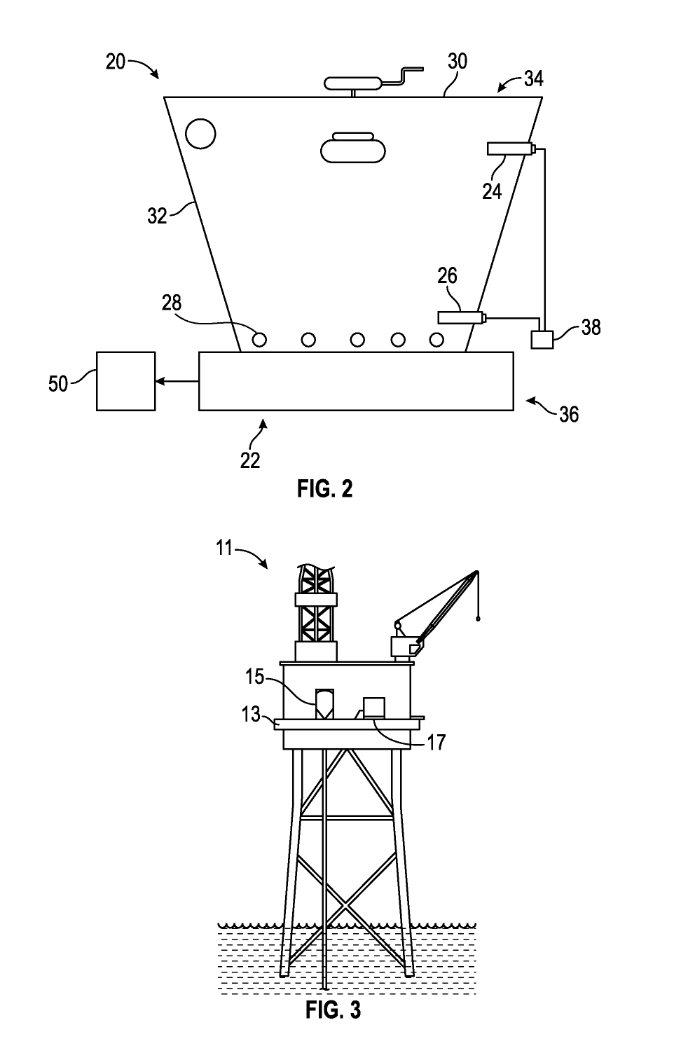

At the bottom of the separator tank, there may be a sediment pump 7 that transfers the solids portion, possibly in the form of sediment slurry, to the nearby skip 8. The content of the sediment slurry may be predominantly barite, mud, oil and water. At the end of the tank cleaning operation, the accumulated oil on top of the water inside the buffer tank 2 may be drained into the skip 8 using an oil drain manifold. Any water that settles out in the skip 8 may be recovered by a pump 9 and a weir bucket 30 (FIG. 2) and resent to the separator 1. In case of water-based mud, the water in the buffer tank 2 may be further cleaned by means of a hydrocyclone 10 with the cleaner water being returned to the buffer tank 2 and the solids being sent to the skip 8. The clean water in the buffer tank is redirected to the TCM feed pump 3 to start the cleaning loop. This continuous closed-loop process may be repeated until the mud tank 6 is fully clean.

FIG. 2 shows a skip 20 in accordance with the present disclosure. The skip 20 may include a feed section that is in operative communication with the rest of the tank cleaning system 100. In one embodiment, the rest of the tank cleaning system 100 except for the skip 20 may define the feed section. The feed section may supply solids to a hollow interior of the skip 20 where the solids can be stored. Moreover, oil may also be supplied to the interior of the skip 20 as discussed above. The skip 20 may include an inlet 34 and an outlet 36 and may further include a first sensor 24 and a second sensor 26 that are located adjacent the inlet 34 and the outlet 36 respectively. The skip 20 may also include a controller 38 that communicates with the first sensor 24 and the second sensor 26 and controls the operations of the skip 20. The first sensor 24 may indicate whether the solids are filled up to a predetermined level of the interior near the inlet 34. The second sensor 26 may indicate whether the solids have been removed from the interior so that the interior is emptied below a given level. The skip 20 may also include an automatic weir bucket 30 and a built-in diffuser 32.

The skip 20 may further include a conveying section 22 that is located downstream of the outlet 36 and is in solids communication with the interior of the skip 20. The skip 20 may also include a dome valve (see reference numeral 20b) adjacent the outlet 36 that controls the opening and closing of the outlet 36 so that movement of solids from the outlet 36 to the conveying section 22 is controlled. The conveying section 22 may be embodied as an auger or pneumatic apparatus depending on the mechanism used for conveyance. While other mechanisms may be contemplated, the conveying section 22 may include a mechanical apparatus such as an auger or screw pump (not shown) or a pneumatic apparatus such as a blower (not shown) that is in communication with a compressed gas source. The skip 20 may further include one or more fluid emitters 28 that are located adjacent the outlet and are directed toward the solids in the interior. The fluid emitter 28 may emit gas with sufficient force to break up the solids that have become compacted near the outlet 36 of the interior. For example, the gas may be air.

After the first sensor 24 indicates that the interior of the skip 20 is filled with solids up to the predetermined level, the feed section may stop supply of solids to the skip 20. Simultaneously or soon thereafter, the conveying section 22 may convey solids away from the skip 20 thereby causing the level of solids to be lowered. As this process continues, the skip 20 may be emptied once the level of solids falls below the given level. After the second sensor 36 indicates that the level of solids as fallen below the given level, the feed section may start supply of solids until the level of solids is above the predetermined level. This continuous cycle of filling and emptying the skip may be repeated until the conveying section 20 conveys or transfers the solids to a downstream disposal section 50.

FIG. 3 illustrates an environment (e.g., offshore oil rig) in which the disposal section 50 may be mounted. The disposal section 50 may be used to handle various types of solids added as agents for the mud or obtained from drilling a borehole.

Referring to FIG. 4, a first embodiment of the disposal section 50, which may be a pressurized vessel 20, is shown. As shown in FIG. 4, a pressurized vessel 20 may be located within a support frame 21. Pressurized vessel 20 has a part spherical upper end 40, a cylindrical body section 41b, and a lower angled section 42. At the lowermost end of the angled section 42, the vessel is provided with a discharge valve 43 having connected thereto a pipe 25. A filling pipe 22 extends into each pressurized vessel 20 via an inlet valve 44 at the upper end 40 of pressurized vessel 20. Also extending into upper end 40 of pressurized vessel 20 is a compressed air line 24 having valves 45.

In a filling operation, prior to loading any solids into pressurized vessel 20, inlet valve 44 is closed. A vent valve (not shown) may be opened to equalize the vessel pressure to ambient air. The inlet valve 44 is opened, and the solids are fed into the pressurized vessel 20. The vent valve may be opened to vent displaced air from the vessel. When the pressurized vessel 20 is full, the inlet valve 44 and vent valve are closed, sealing the pressurized vessel. In order to empty a vessel that is filled via pipe 22, inlet valve 44 is closed, valve 43 is opened, and compressed air is fed into the vessel 20 via air line 24. The solids are forced out of vessel 20 under the pressure of the compressed air and into pipe 25. While the above embodiment refers to application of compressed air into the pressurized vessel, one of ordinary skill in the art would recognize that it is within the scope of the present disclosure that other inert gases, for example, compressed nitrogen, may be used in place of compressed air. In a particular embodiment, the compressed gas applied to the pressurized vessel may be within a pressure ranging from about 4 to 8 bar.

Due to the angle of the lower angled section being less than a certain value, the material flow out of the vessel is of the type known as mass flow and results in all of the material exiting uniformly out of the vessel. In the case of mass flow, all of the solids material in the vessel descend or move in a uniform manner towards the outlet, as compared to funnel flow (a central core of material moves, with stagnant materials near the hopper walls). It is known that the hopper angle (to achieve mass flow) may vary depending upon the material being conveyed and/or the vessel material. In various embodiments, the angle (from the vertical axis) for mass flow to occur may be less than 40 degree. One of ordinary skill in the art would recognize that in various embodiments the lower angled section may be conical or otherwise generally pyramidal in shape or otherwise reducing in nature, e.g., a wedge transition or chisel, to promote mass flow. In a particular embodiment, the lower angled section has a minimum discharge dimension of at least about 5 inches (127 mm). The lower angled section may have a discharge dimension that is sized for the desired flow rate of the system 50. In some embodiments, the lower angled section discharge dimension is about 6 inches (152 mm), about 8 inches (203 mm), about 10 inches (254 mm), or about 12 inches (300 mm). After exiting the vessel, the material is typically conveyed in the form of a semi-solid slug along pipe 25.

Referring to FIG. 5, a different embodiment of the pressurized vessel is shown. As shown in FIG. 5, pressurized vessel 30 has an upper end 46, a body section 47, and a lower angled section 48. Connected at its upper end 46 is feed hopper 32 with an inlet valve 49 therebetween. At the lowermost end of the conical section 48, the vessel is provided with a discharge valve 60.

In a filling operation, inlet valve 49 is opened, and the solids are fed into the pressurized vessel 30 through the feed hopper 32, which may optionally be a vibrating feed hopper. When the pressurized vessel 30 is full, the inlet valve 49 is closed, sealing the pressurized vessel. In order to empty the valve, inlet valve 49 remains closed, discharge valve 60 is opened, and compressed air is fed into the vessel 30 via an air line (not shown). The solids are forced out of vessel 30 under the pressure of the compressed air and into a discharge pipe (not shown). Due to the selected angle of the lower angled section being less than a certain value, the material flow out of the vessel is of the type known as mass flow and results in all of the material exiting uniformly out of the vessel.

One of ordinary skill in the art would recognize that in different embodiments, any number of pressurized vessels may be used, which may be connected in series or with a common material filling pipe and a common material discharge pipe. In a particular embodiment, solids may be conveyed from the tank cleaning system into a pressurized vessel having a feed chute attached thereto, such as that described in FIG. 5, and then be discharged from the first pressurized vessel and conveyed into a second pressurized vessel, such as that described in FIG. 4.

Pressurized vessel 20 may be filled with solids by various means. In one embodiment, filling pipe 22 and thus inlet valve 44, which empty solids into pressurized vessel 20, may be supplied with solids for processing by vacuum assistance.

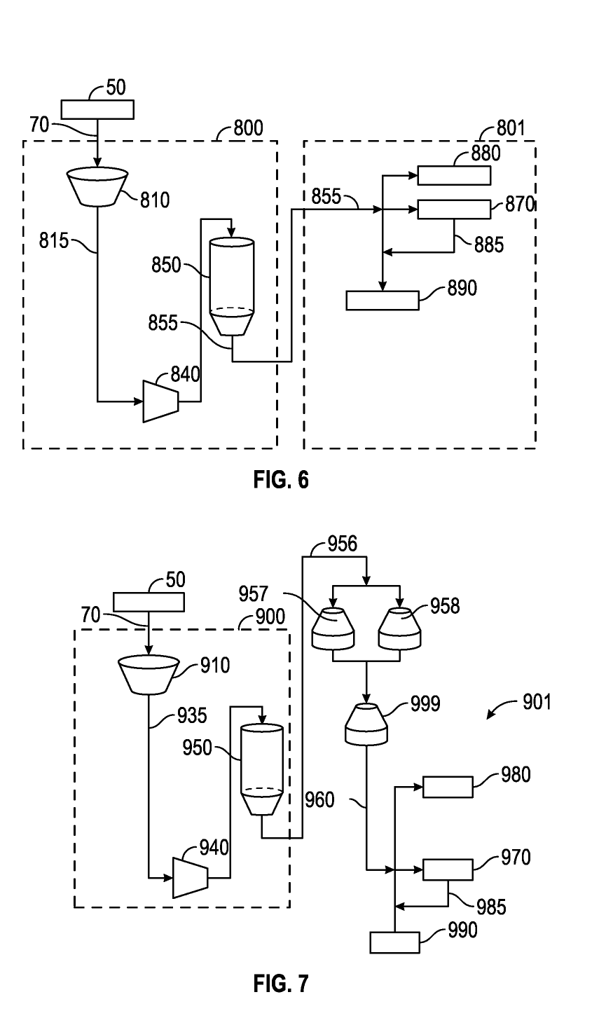

Referring to FIG. 6, a second embodiment of the disposal section 50 with a slurrification system 800 and a solids re-injection system 801 is shown. In this embodiment, slurrification system 800 may be in solids communication with the treatment system 50, which may correspond to the tank cleaning system discussed above. The recovered solids 70 from the tank cleaning system enter slurrification process 800. In slurrification process 800, the solids are processed by a buffer tank 810. The solids are mixed with a fluid in the buffer tank 810 and fed to a pump 840 through transfer line 815, wherein the resulting slurry is transferred to a storage vessel 850. In this embodiment, the slurry exits the slurrification system and is introduced into solids re-injection system 801 via a CRI transfer line 855. In this embodiment, the slurry may be transferred to a classifier 870. In one aspect, classifier 870 determines the size range of the slurry based on diameter (i.e., particle size) and discharges the slurry to solids re-injection system 801 via a transfer line 885.

In another embodiment, classifier 870 may transfer the slurry to a high-pressure injection pump 890 disposed proximate wellbore via transfer line 885. As the slurry is produced by slurrification system 800, injection pump 890 may be actuated to pump the slurry into a wellbore (not independently shown). Those of ordinary skill in the art will appreciate that the re-injection process may be substantially continuous due to the operating conditions of the slurrification system. In-line slurrification systems may be continuously supplied solids from a drilling operation, thereby producing a substantially continuous supply of slurry for a solids re-injection system. Thus, once a solids re-injection cycle is initiated, it may remain in substantially continuous operation until a drilling operator terminates the operation.

In aspects of this embodiment, the slurry may enter high-pressure pumps (not independently shown), low-pressure pumps (not independently shown), or both types of pumps, to facilitate the transfer of the slurry into a wellbore. In one embodiment, the pumps may be in fluid communication with each other, so as to control the pressure at which the slurry is injected downhole. However, to further control the injection of the slurry, additional components, such as pressure relief valves (not independently shown) may be added in-line prior to the dispersal of the slurry in the wellbore. Such pressure relief valves may help control the pressure of the injection process to increase the safety of the operation and/or to control the speed of the injection to further increase the efficiency of the re-injection. The slurry is then transferred to downhole tubing for injection into the wellbore. Downhole tubing may include flexible lines, existing piping, or other tubing know in the art for the re-injection of solids into a wellbore.

In one embodiment, the slurry may be transferred to a temporary storage vessel 880, wherein the slurry may be stored for future use in periods of overproduction. Temporary storage vessel may include vessels discussed above, such as, for example, ISO-vessels or other storage vessels that operate in accordance with the present disclosure.

Referring to FIG. 7, a different configuration of a slurrification system 900 and a solids re-injection system 901 is shown. In this embodiment, slurrification system 900, may be in solids communication with the treatment system 50, which may correspond to the tank cleaning system discussed above, and a solids re-injection system 901. As described above, solids are processed by treatment system 50, wherein the recovered solids 70 enter slurrification process 900. In slurrification process 900, the solids are processed by a buffer tank 910 and a transfer line 935. The solids are mixed with a fluid in the buffer tank 910 and transferred to a pump 940 via transfer line 935, wherein the resulting slurry is transferred to a storage vessel 950. In the embodiment shown in FIG. 9, the slurry exits slurrification system 900 and is introduced into solids re-injection system 901 via a CRI transfer line 956. In one embodiment, slurrification system 900 may be combined with other slurrification systems known in the art. For example, the slurry may pass through slurrification system 900 and move on to a series of additional slurrification devices, such as a coarse tank 957, a fines tank 958, and a batch holding tank 999. After slurrification, the slurry may be transferred to a high pressure pump 990, temporary storage 980, and/or classifier 970 via transfer line 960, as discussed above. Once the slurry enters classifier 970, it may be directed to high pressure pump 990 via a transfer line 985.

In one embodiment, a sensor (e.g., a density sensor, a viscometer, and/or a conductivity sensor) may be operatively coupled to a valve to open or close the valve when a pre-determined condition of the slurry is met. For example, in one embodiment, a density sensor may be coupled to a valve, such that, when the density of the slurry exiting a pump reaches a pre-determined value, the valve moves (i.e., opens or closes), and redirects the flow of the slurry from a storage vessel to a second storage vessel, a slurry tank, a skip, or an injection pump for injection into a formation.

In another embodiment, a conductivity sensor may be coupled to a valve, such that, when the density of the slurry exiting a pump reaches a pre-determined value, the valve moves and redirects the flow of the slurry from storage a vessel to a second storage vessel, a slurry tank, a skip, or injection pump for injection into a formation. Those of ordinary skill in the art will appreciate that other apparatus and methods may be used to redirect the flow of the slurry once a specified condition (i.e., density, conductivity, or viscosity) is met.

In yet another embodiment, the flow of solids, fluids, and other contents of the slurrification system may be controlled by an operatively connected programmable logic controller (“PLC”). The PLC may contain instructions for controlling the operation of a pump; such that a slurry of a specified solids content may be produced. Additionally, in certain aspects, the PLC may contain independent instructions for controlling the operation of the pump inlet or outlet. Examples of instructions may include time dependent instructions that control the time the slurry remains in a pump prior to transference through an outlet. In other aspects, the PLC may control the rate of dry material injected into a pump, or the rate of fluid transmittance through, or into, a transfer line. In still other embodiments, the PLC may control the addition of chemical and/or polymer additives as they are optionally injected into a transfer line. Those of ordinary skill in the art will appreciate that the PLC may be used to automate the addition of dry materials, fluids, and/or chemicals, and may further be used to monitor and/or control operation of the slurrification system or pump. Moreover, the PLC may be used alone or in conjunction with a supervisory control and data acquisition system to further control the operations of the slurrification system. In one embodiment, the PLC may be operatively connected to a rig management system, and may thus be controlled by a drilling operator either at another location of the work site, or at a location remote from the work site, such as a drilling operations headquarters.

The PLC may also include instructions for controlling the mixing of the fluid and the solids according to a specified mixing profile. Examples of mixing profiles may include step-based mixing and/or ramped mixing. Step-based mixing may include controlling the mixing of solids with the fluid such that a predetermined quantity of solids are injected to a known volume of fluid, mixed, then transferred out of the system. Ramped mixing may include providing a stream of solids to a fluid until a determined concentration of solids in reached. Subsequently, the fluid containing the specified concentration of solids may be transferred out of the system.

In another embodiment, a density sensor may be integral with a mixing pump, in-line before or after a storage vessel, and/or coupled to a valve anywhere in the slurrification process prior to the solids re-injection system, as discussed above. A valve coupled to the density sensor will allow for recirculation of the slurry through the slurrification system until the density of the slurry reaches a value determined by requirements of a given operation. In one embodiment, a valve, coupled with a density sensor and integral to a mixing pump, moves (i.e., opens or closes) and redirects the flow of the solids back to a buffer tank for further processing through a slurrification system. This embodiment provides a method for producing a slurry with an environmentally acceptable density.

In another embodiment, a conductivity sensor may be coupled to a valve, integral with a mixing pump, in-line before or after a storage vessel, and/or coupled to a valve anywhere in the slurrification process prior to the solids re-injection system, as discussed above. A valve coupled to the conductivity sensor will allow for recirculation of the slurry through the slurrification system until the conductivity of the slurry reaches a value determined by requirements of a given operation. In one embodiment, a valve, coupled with a density sensor and integral to a mixing pump, moves (i.e., opens or closes) and redirects the flow of the solids back to a buffer tank for further processing through a slurrification system. Those of ordinary skill in the art will appreciate that other apparatus and methods may be used to redirect the flow of the slurry once a predetermined concentration of solids in suspension, density, or conductivity has been met.

In one embodiment, the slurrification system may be substantially self-contained on a skid. A skid may be as simple as a metal fixture on which components of the slurrification system are securably attached, or in other embodiments, may include a housing, substantially enclosing the slurrification system. When the slurrification system is disposed on a skid, a drilling operation that utilizes a system that may benefit from increased solids content in a re-injection slurry, the slurrification system may be easily transported to the work site (e.g., a land-based rig, an off-shore rig, or a re-injection site). Those of ordinary skill in the art will appreciate that while the slurrification system may be disposed on a rig, in certain embodiments, the slurrification system may include disparate components individually provided to a work site. Thus, non-modular systems, for example those systems not including a skid, are still within the scope of the present disclosure.

Solids transfer systems, slurrification systems, and solids re-injection systems, as described above, are typically independent systems, where the systems may be located on rig permanently or may be transferred to rig from a supply boat when such operations are desired. However, in embodiments disclosed herein, a system module may be located on a rig proximate solids storage vessels, and transfer lines may be connected therebetween to enable use of the solids storage vessels with tanks, pumps, grinding pumps, chemical addition devices, cleaning equipment, water supply tanks, solids dryers, and other components that may be used in other operations performed at a drilling location. Furthermore, embodiments of the present disclosure may be integrated to slurrification systems wherein the slurry is created in transit between collection points (i.e., at a rig or platform) and at an injection point (i.e., at a second rig, platform, or land-based drilling operations/injection site).

Advantageously, embodiments of the present disclosure provide for at least one of the following. Disposal of solids obtained from tank cleaning may be expedited and facilitated by the pneumatic conveyance of the solids. Thus, efficiency in transportation and treatment of the solids may be obtained. The coupling between the tank cleaning system and the slurrification system/solids re-injection system can allow for disposal of solids otffshore and eliminate the need for transportation of solids for disposal onshore.

A system includes a skip, a first sensor and a conveying section. The skip includes a hollow interior to store solids therein. The skip further includes an inlet and an outlet. The first sensor is located adjacent the inlet to indicate that the interior is filled with solids up to a predetermined level. The conveying section is located downstream of the outlet and is in solids communication with the interior. After the first sensor indicates that the interior is filled with solids up to the predetermined level, the conveying section conveys solids away from the skip and the skip is emptied.

A method includes cleaning a tank to remove solids therefrom. The method further includes filling a skip with solids from the tank, the skip including a hollow interior. The method further includes sensing whether the interior is filled with solids up to a first predetermined level. The method further includes stopping the filling. The method further includes conveying solids away from the skip after the interior is filled with solids up to a first predetermined level.

A system including a tank, a tank cleaning machine, a water recycling unit, a skip and a disposal section. The tank cleaning machine cleans the tank with water and generates slop therefrom. The water recycling unit separates slop from the tank into water and solids. The skip includes a hollow interior to store solids therein and is in solids communication with the water recycling unit and including a conveying section. The conveying section conveys the solids to the disposal section which disposes of the solids.

Although the preceding description has been described herein with reference to particular means, materials, and embodiments, it is not intended to be limited to the particulars disclosed herein; rather, it extends to all functionally equivalent structures, methods, and uses, such as are within the scope of the appended claims.

What is claimed is:

1. A system including:
a skip including a hollow interior to store solids therein, the skip further including an inlet and an outlet;
a first sensor located adjacent the inlet to indicate that the interior is filled with the solids up to a predetermined level;
a conveying section located downstream of the outlet and in solids communication with the interior,
wherein, after the first sensor indicates that the interior is filled with the solids up to the predetermined level, the conveying section conveys the solids away from the skip and the skip is emptied.

2. The system of claim 1, further including a feed section to supply the solids to the interior of the skip.

3. The system of claim 2, wherein the feed section is configured to stop supply of the solids after the first sensor indicates that the interior is filled with the solids up to the predetermined level.

4. The system of claim 1, further including a second sensor to indicate that the interior is empty below a given level.

5. The system of claim 4, wherein the feed section is configured to start supply of the solids after the second sensor indicates that the interior is emptied below a given level.

6. The system of claim 1, wherein the conveying section includes an auger.

7. The system of claim 1, wherein the conveying section includes a blower.

8. The system of claim 7, wherein the system includes a dome valve adjacent the outlet.

9. The system of claim 1, further including a fluid emitter directed toward the solids in the interior.

10. The system of claim 9, wherein the fluid emitter includes a plurality of emitters adjacent the outlet of the skip.

11. A method including:
cleaning a tank to remove solids therefrom;
filling a skip with the solids from the tank, the skip including a hollow interior;
sensing whether the interior is filled with the solids up to a first predetermined level;
stopping the filling; and
conveying the solids away from the skip after the interior is filled with the solids up to a first predetermined level.

12. The method of claim 11, further including re-cleaning the tank and re-filling the skip with the solids from the tank.

13. The method of claim 11, further including emitting fluid on the solids in the tank.

14. The method of claim 11, wherein the conveying is conducted pneumatically.

15. The method of claim 11, wherein the conveying is conducted mechanically.

16. The method of claim 11, further including separating the solids from slop formed during the cleaning.

17. A system including:
a tank;
a tank cleaning machine to clean the tank with water and generate slop therefrom;
a water recycling unit to separate slop from the tank into water and solids;
a skip with a hollow interior to store the solids therein, the skip in solids communication with the water recycling unit and including a conveying section; and
a disposal section to which the conveying section conveys the solids and which disposes of the solids.

18. The system of claim 17, wherein the disposal section includes a pressurized vessel.

19. The system of claim 17, wherein the disposal section includes a slurrification system and a solids re-injection system.
